(19) United States
(12) Patent Application Publication
(10) Pub. No.: US 2002/0126889 A1
(43) Pub. Date: Sep. 12, 2002

(54) PROCEDURE FOR IDENTIFICATION OF OBJECTS BASED ON FORMING AND VERIFYINGTHEIR SURFACE ROUGHNESS AS WELL AS OBJECTS SUITABLE TO BE INDENTIFIED

(76) Inventors: LAJOS PIKLER, BUDAORS (HU); GYULA JESZENSZKY, BUDAORS (HU)

Correspondence Address: RATNER & PRESTIA, P.O. BOX 7228, WILMINGTON, DE, 19803, US

(21) Appl. No.: 08/765,979

(22) PCT Filed: Jul. 3, 1995
(86) PCT No.: PCT/HU95/00032

(30) Foreign Application Priority Data
Jul. 25, 1994 (HU) P 94 02179

(51) Int. Cl. G06K 9/00

(52) U.S. Cl. 382/154

(57) ABSTRACT

The invention relates to a procedure for identification of an object, based on forming and verifying its surface roughness, in which a marking that makes its surface rough will be produced on the object and the picture and/or the code of the marking, preferably together with other identification data of the object, will be stored in the storage of a computer and/or on a portable storage means and, when identifying, the picture and/or the code of the marking placed on the object will be compared to those/that stored. The characteristic feature of the procedure is that, the 3-dimension marking containing the elementary formations of roughness in a chaotic arrangement will be produced by means of a printing surface processed by using stochastic electro-erosion and/or by means of stochastic electro-erosion. The invention also relates to an object suitable to be identified, provided with a marking produced according to any of the claims 1 to 7 and/or by means of other physical- and/or chemical way on its optically accessible surface. The novelty of the invention is that, the elementary formations of the surface roughness are of chaotic arrangement.

### The invention relates-to a procedure for identification of an object. based on forming and verifying its surface roughness. in which a marking that makes its surface rough will be produced on the object and the picture and/or the code of the marking, preferably together with other identification data of the object, will be stored in the storage of a computer and/or on a portable storage means and. when identifying, the picture and/or the code of the marking placed on the object will be compared to those/that stored.

The invention also relates to an object suitable to be identified, for the purpose of putting special marks on especially locking labels used for sealing the package of goods, furthermore, bar codes, bank notes, credit cards. official documents, certificates, deeds, transport vouchers, lead seals, machines such as traffic means, military means and objects, in order to prevent and reveal, respectively, any counterfeit and malpractice.

A number of various technical solutions used for protection against any counterfeit of objects, especially locking labels used for sealing the package of goods, furthermore, bar codes, bank notes, credit cards, official documents, certificates, deeds, transport vouchers, lead seals, machines such as traffic means, military means and objects have existed for long time. However, the solutions that become known represent effective protection only until the counterfeiters having more advanced technology make the markings serving for protection repeatable and make the secret safety codes suitable to be detected and copied.

The literature of patents describes several solutions in which markings hidden by using, various methods are placed on the surface of objects. For example. the patent specification of registration No. U.S. Pat. No. 4,988,126 describes a method for additional marking of embossed documents, by using luminescent compositions arranged in the high/convex and/or low concave zones, thus giving the relief print a stereoscopic reflection feature which can be verified by both visual inspection and using an appropriate device. This enables the data included in the document to be verified in a simple way, in respect of both alteration and counterfeit. This solution requires a special marking that, in any case, shall be adapted to the content of document; in addition, it can only be used for documents.

The present invention is aimed at developing a solution suitable to prevent any counterfeit or make it detectable, which can universally be used for various objects and can be implemented by using relatively simple technology while making any copy for the purpose of counterfeit impossible even having the conditions of its implementation became known.

One of the principles of the invention is based on the recognition that, if the 3-D marking that represents some roughness on the surface consists of elementary formations of chaotic arrangement produced bag means of a stochastic process, the marking thus produced is unable to be reproduced with full identity.

Consequently, if a marking of such kind is produced by means of a stochastic process on the surface of some objects this marking, in itself is suitable to mark that object in a distinct manner. In this case, the object may be the object itself to be protected against any counterfeit, or even, a print matrice that can be used to provide surface markings in a documented manner on various objects to be protected against any counterfeit. Markings of this kind can be obtained by exposing an area to stochastic effects of electro-erosion.

In this case the electro-erosion is defined as a permanent alteration of some surface by means of particles with electric charge: while the stochastic electro-erosion consists of an electro-erosion process in which the mutual effect between the surface and the particles is controlled by random events.

According to a further recognition the stochastic effects manifest themselves to the largest extent in an electric arc, in which the concentrated very high-energy effect of the electric flash-over of duration less than one nanosecond virtually tears out a chip from the surface. This phenomenon occurs e.g. when opening electric contacts: however, according to a further realization, its practical implementation can the most closely be approached by the electro-erosion procedure.

According to a further realization, an object provided with some marking can be identified any time, based on the establishment and storage of the picture and/or the code of marking. The simplest way of establishing the picture consists in the use of a video-camera where the video-code can simply be used as the code of marking. The verification can be performed e.g. in an on-line manner known in itself.

According to the objective set, the present invention relates to a procedure for identification of objects, based on forming and verifying its surface roughness, in which a marking that makes its surface rough will be produced on the object and the picture and/or the code of the marking, preferably together with other identification data of the object, will be stored in the storage of a computer and/or on a portable storage means and, when identifying, the picture and/or the code of the marking placed on the object will be compared to those that stored, based on that the 3-dimension marking containing the elementary formations of roughness in a chaotic arrangement will be produced by means of a printing surface processed by using stochastic electro-erosion and/or by means of stochastic electro-erosion.

According to a further criterion, electro-erosion equipment will be used to implement the procedure of electro-erosion.

In one version of the invention the parameters of the electro-erosion equipment will be set as follows idle voltage is 60 to 100 V, peak current: 6 to 25 Å: pulse width: 50 to 800 μs: break between pulses: 10 to 800 μs.

Any of or all the adjustable parameters of the electro-erosion equipment will be controlled by means of a generator, Random- or quasi-random generator is used as the generator.

In another version of the procedure the marking will be produced on a print matrice. The marking prepared on the print matrice will be printed if necessary on paper, metal sheet, metal strip and/or plastic sheet containing other items of information and the print will be covered by some transparent material if necessary.

A further criterion of the procedure is, that the picture of marking will be produced with the marked object being in its proper state, thus, with packages sealed and component parts built in. The picture and/or autotropic- and or parametric optics. The picture and/or the code of marking will be produced by using an optical interferometer.

If the difference between the code of marking produced last by means of the print matrice and the code of previous marking exceeds the applied tolerances, the print matrice will be replaced or the changes in the code documented. The printing surface containing the marking will be reprocessed when renewing the print matrice.

Furthermore, the present invention relates to an object suitable to be identified, provided with a marking produced by means of physical- and/or chemical way on its optically accessible surface, designed in a manner that the elementary formations of the surface roughness are of chaotic arrangement.

A farther criterion of the object is that the marking contains elevations, craters, hollows and channels established from the elementary formations of surface roughness in a chaotic arrangement. The size of the elementary formations of surface roughness lies between 0.1 and 30 μm.

A significant advantage of the present invention is, that it can be equally applied to the surface of various objects in order to detect and prevent any counterfeit, and the marking itself its picture and/or code can be produced, stored and identified in a simple and reliable manner.

A further advantage of the invention is that, if a counterfeiter were able to localize the marking and determine the code used for the identification the technical solutions available at present would still be unable to produce an accurate copy of the marking. In fact, this would require the control of electro-erosion processes with response times shorter than one nanosecond. The imitation of the chaotic arrangement can also be verified and detected by forming and analyzing distribution functions. Should, however, an attempt be made to counterfeit by using e.g. micro-laser technology, the melting traces characterizing this procedure remained on the surface could easily be detected. In addition. the micro-laser technology is unable to produce patterns below 10 μm resolution on metallic surfaces at present.

The production of print matrices according to the invention and their use for marking are suitable to put individual marks not only on packaged goods, but also on bank notes, credit cards, official documents certificates, deeds, transport bills and metallic seals in a manner that they will become unable to be counterfeited. In addition, they can also be used to put marks on metallic strips inserted in certain securities. The markings can also be documented in an up-to-date manner, thus making the objects thus marked suitable to be identified by using various methods, even immediately if so required.

A further advantage is, that the effect of the electric arc of stochastic character already in itself can be further increased, by controlling any of or all the controllable parameters of the electro-erosion equipment by means of a—preferably random—or quasi random—generator.

This solution has the further advantage that the characteristic size of the elementary formations can be reduced to as small as 0.1 μm. which also enables the markings to be hidden virtually on very fine surfaces. In such cases, however, ultraviolet optical systems or an optical interferometer or other optical methods will be needed to establish the picture.

The further advantages and application possibilities of the invention will be presented by means of examples. However, it shall be noted that there are a number of application possibilities beyond those described by the examples.

Example 1

A print matrice to be used for additional marking will be produced, in order to detect any counterfeit of locking labels used for sealing packaged goods. The print matrice will be made of steel of K1 quality, hardened to HRC-60, designed as a cylinder of 8 mm diameter, with the marking placed on one of the end plates. The operational parameters of the electro-erosion equipment will be set as follows:

idle voltage: 60 to 100 V, preferably 80 V;

peak current: 6 to 25 Å:

pulse width: 50 to 800 μs:

break between pulses: 50 to 800 μs.

In this case. the above mentioned parameters of the electro-erosion equipment can be set in three to file rough stages. with the possibility of fine adjustment within each stage. Any of the parameters will be controlled by means of a random- or quasi-random generator, the output of which controls the rough stages to the risen parameter. Fuel oil, petroleum, transformer oil, kerosene or any SOE oil derivative or their mixture can be used as a dielectric for the electro-erosion procedure.

The electro-erosion procedure shall take 1 to 20 minutes. The finished printing surface contains elevations, craters, hollows and channels in a random arrangement. The printing surface obtained will be marked A.

Then. another printing surface with the same conditions will be produced on the same print matrice, which will be marked B.

By using the print matrices, the metallic insert sheet of the locking labels provided with printed text will be marked and, then the metal sheet will be covered with plastic sheet in a known manner and, finally, the locking labels will be placed in a known manner on the packaging of goods.

In the next step, the picture of the marks A and B placed on the locking labels will be obtained. by means of a video recorder. The digitized video, pictures represent the video codes A and B, respectively, which will be stored in a computer. Any other characteristics of the given series of goods can also be stored in the same storage area.

When identifying the given product, the video picture and the video code of the mark placed on the blocking label will be prepared and compared in a known manner with the video code stored in the computer.

The results of the example 1 are presented by the figures listed below:

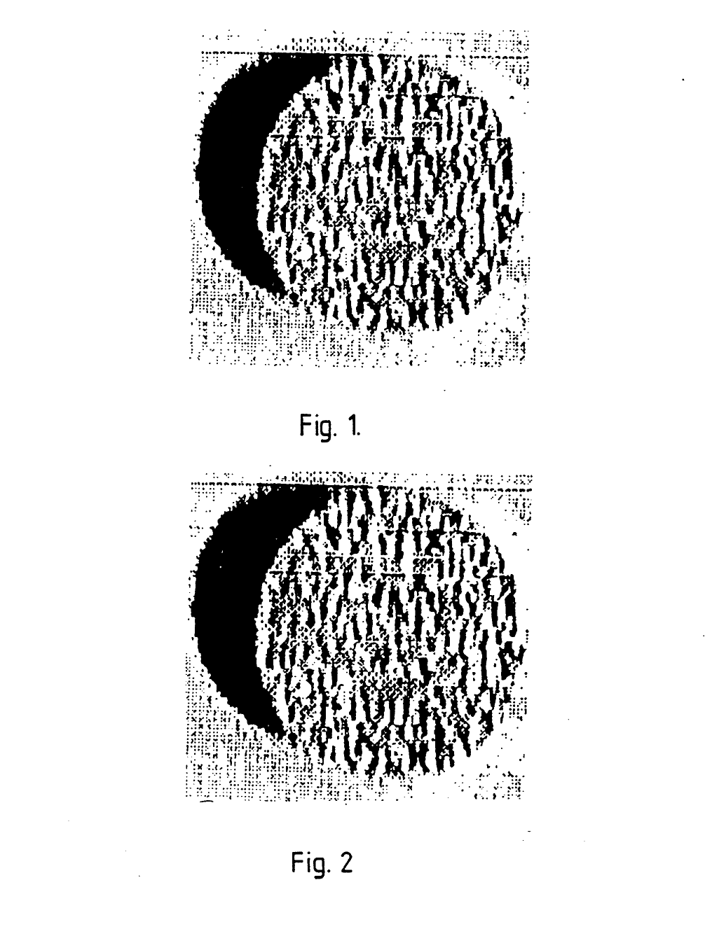

FIG. 1 shows the video picture A

FIG. 2 shows the video picture B

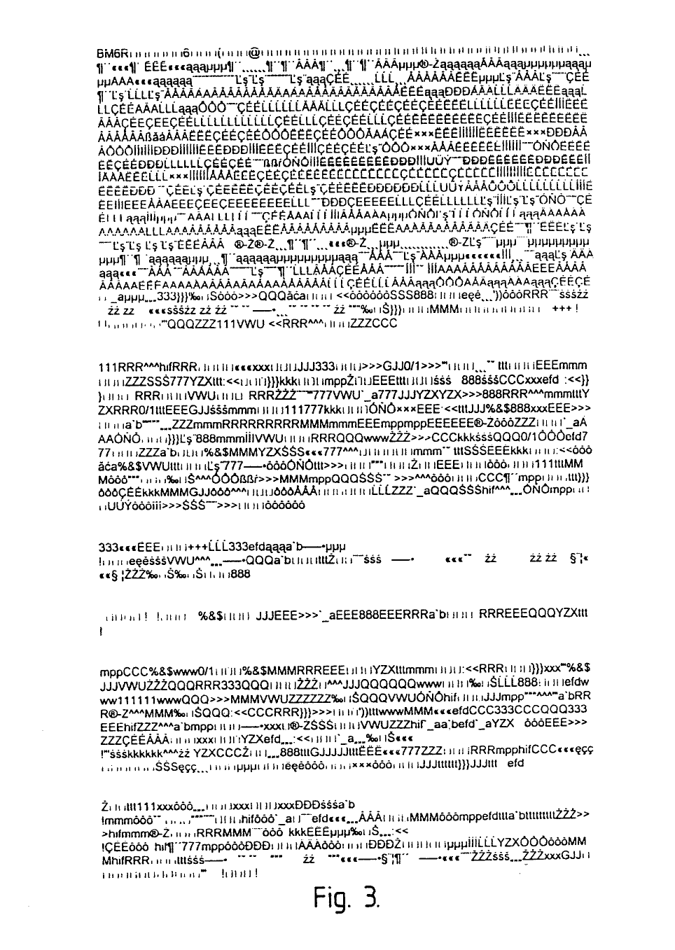

FIG. 3 shows the video code A

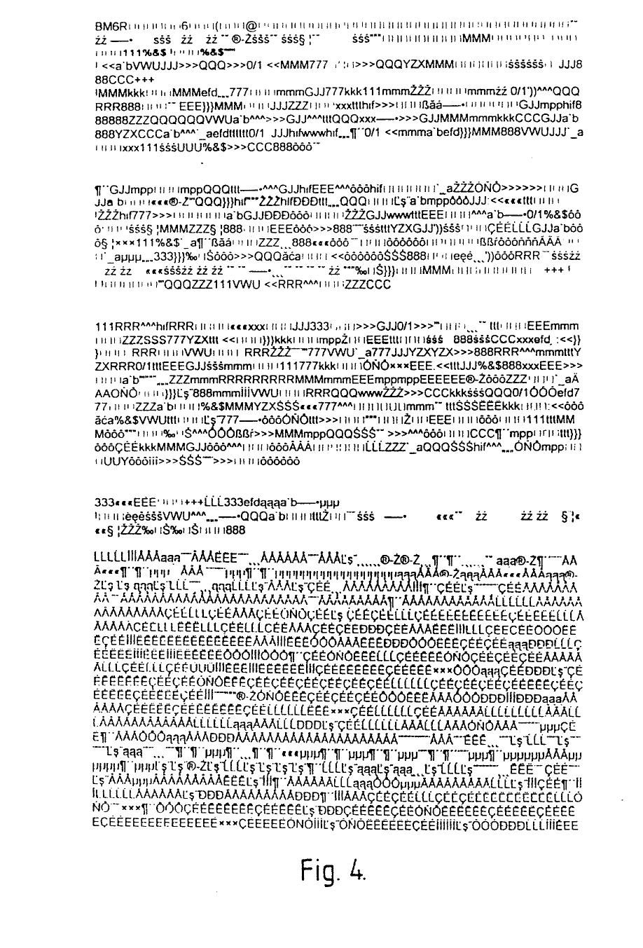

FIG. 4 shows the video code B.

The FIGS. 1 and 2 show the video pictures in a tenfold magnification. In our case. no deviations are visible to the naked eye. However, as stochastic processes take place during the electro-erosion, it is also possible that differences visible to the naked eve can be observed when repeating the operations described in this example.

The video codes shown in the FIGS. 3 and 4 are different even in our case; thus, they enable the locking labels marked by using the printing surfaces A and B and any other objects, respectively, to be distinguished.

Should any of the print matrices in use be worn out, its video code will suffer some changes. By documenting the changes, the print matrice remains suitable for further use, with a new surface prepared by means of electro-erosion in place of the worn surface, represented by a new video code, or even, the old print matrice can be replaced by a new one, represented by a new video code. With proper documentation, this is not considered a disadvantage; instead, it causes further difficulties to counterfeiters.

Example 2

A motor car component part will be marked in the manner described in the Example 1. For this purpose a component part to be built-in and made in mass production or an accessible surface of some component part already built in a motor car in use can be used.

The video code of the marking will be established and stored in a computer, together with other ID data of the motor car.

Several parts of a motor car will be marked and their video codes together with other ID data of the motor car will be stored either on magnet card as a completion to the traffic license and/or in a storage chip. The identification will be performed in a known manner.

In addition to the description of an exemplary implementation of the procedure according to the invention, the Example 1 also shows that the printing surfaces will not be the same even under the same conditions for producing the print matrices. Indeed, the probability of obtaining the same optic pictures for the surfaces both A and B will be 10-19 or less. It is also proved that the markings printed on metal sheets can be identified by using simple video technique and by comparing their video codes by means of a computer.

The method described in the Example 2 is suitable to provide the surfaces on conductible, metallic parts of machines such as traffic means, military equipment and objects etc. with individual markings that are unable to be copied and counterfeited. Furthermore, it also enables the markings to be properly documented, thus making the objects marked suitable to be identified by using various methods even immediately if so required.

In the above examples, the average roughness of the markings will be around 10 μm. The size of formations varies between 0.4 to 15 μm and can be controlled by the material of the part and/or the electrode and/or the dielectric, and/or the parameters of the electro-erosion equipment. By reducing the pulse width and/or pulse break below 50 μs, preferably between 10 and 50 μs, and/or by reducing the peak current below 6 A preferably between 2 and 6 A, the lower limit size of formations can be reduced below 0.4 μm. Thus, the space requirement of the marking can also be reduced, which makes the detection by third persons more difficult. In such cases, the picture and/or the code cannot be produced any more by means of video technique operating in the frequency range of visible light: however, by using an ultraviolet camera and/or other mapping methods e.g. optical interferometer and/or autotropic and/or parametric optic, this problem can be solved.

Example 3

By using the technique described above, webs of keys for locks were marked. In the locking device itself, an optic reader subassembly suitable to identify stochastic patterns created by electro-erosion as well as a microprocessor-based unit of identification were arranged.

When the key is inserted into the lock, the optic reader subassembly reads the identifier marking established on the web of the key, while activating the unit of identification which, based on its own programmed algorithm, compares the pattern previously stored to the pattern read by the optic reader. If the two patterns are identical, that is, their digitized sequences coincide, the locking device will be opened, otherwise it remains locked.

In addition to electro-erosion equipment, other procedures of stochastic electro-erosion can also be used to produce marking, e.g. by opening electric contacts and/or pulses of amplitude exceeding the flash-over voltage, or by means of procedures that take place e.g. in an electric plasma. However. it is well known that these phenomena that are disadvantageous in respect of electrotechque led to the practical implementation of the electro-erosion technology. The process of electro-erosion can also be evoked in an electrochemical way; nevertheless, its stochastic character can only be ensured by means of special procedures.

Furthermore, it shall be noted that. in addition to the stochastic electro-erosion, the markings of chaotic arrangement according to the present invention can also be produced by means of other physical or chemical procedures, e.g. by chemical corrosion and/or grinding.

The marking included in the print matrice can be printed on various materials, such as paper, metal sheet, metal strip, plastic sheet; furthermore, the print can be protected against any counterfeit by covering it with some transparent material in a known manner if required.

It is advantageous to produce the picture and/or the code of marking with the marked object being in its proper operational state and place, e.g. component parts built in or packages sealed. In fact, it is under such circumstances that the possibility of obtaining the same results will be the highest when producing pictures and/or codes repeatedly.

Further advantages will be achieved if the quality of print matrice can be monitored on the basis of possible changes in the code of marking printed by that print matrice. Thus, if the code of the marking printed last shows differences beyond the permissible tolerances as compared to the code of marking printed second last, this means that the print matrice became worn. In this case, the new code can be documented or the print matrice can be renewed or a new print matrice can be used. Worn print matrices can also be renewed by reprocessing the printing surface containing the marking e.g. by using electro-erosion.

1. Procedure for identification of an object, based on forming and verifying, its surface roughness, in which a marking that makes its surface rough will be produced on the object and the picture and/or the code of the marking, preferably together with other identification data of the object, will be stored in the storage of a computer and/or on a portable storage means and, when identifying, the picture and/or the code of the marking placed on the object will be compared to those/that stored, characterized by that, the 3-dimension marking containing the elementary formations of roughness in a chaotic arrangement will be produced by means of a printing surface processed by using stochastic electro-erosion and/or by means of stochastic electro-erosion.

2. Procedure as in claim 1, characterized by that. electro-erosion equipment will be used to implement the procedure of electro-erosion.

3. Procedure as in claim 2. characterized by that, the parameters of the electro-erosion equipment will be set as follows idle voltage: 60 to 100 V, peak current: 6 to 25 A; pulse width: 50 to 800 μs; break between pulses: 10 to 800 μs.

4. Procedure as in claim 2 or 3, characterized by that, any of or all the adjustable parameters of the electro-erosion equipment will be controlled by means of a generator.

5. Procedure as in claim 4, characterized by that, a random- or- quasi-random generator is used as the generator.

6. Procedure as in any of the claims 1 to 5, characterized by that, the marking will be produced on a print matrice.

7. Procedure as in claim 6, characterized by that, the marking prepared on the print matrice will be printed if necessary on paper, metal sheet. metal strip and/or plastic sheet containing other items of information and the print will be covered by some transparent material if necessary.

8. Procedure as in any of the claims 1 to 7, characterized by that, the picture of marking will be produced with the marked object being in its proper state, thus, with packages sealed and component parts built in.

9. Procedure as in any of the claims 1 to 8, characterized by that, the picture and/or the code of marking will be produced by using video record and/or autotropic- and/or parametric optics.

10. Procedure as in any of the claims 1 to 8, characterized by that, the picture and/or the code of marking will be produced by using an optical interferometer.

11. Procedure as in any of the claims 1 to 10, characterized by that, if the difference between the code of marking produced last by means of the print matrice and the code of previous marking exceeds the applied tolerances, the print matrice will be replaced or the changes in the code documented.

12. Procedure as in claim 11, characterized by that, the printing surface containing the marking will be reprocessed when renewing the print matrice.

13. An object suitable to be identified, provided with a marking produced according to any of the claims 1 to 7 and/or by means of other physical- and/or chemical way on its optically accessible surface, characterized by that, the elementary formations of the surface roughness are of chaotic arrangement.

14. Object as in claim 13, characterized by that, the marking contains elevations, craters, hollows and channels established from the elementary formations of surface roughness in a chaotic arrangement.

15. Object as in claim 13 or 14, characterized by that, the size of the elementary formations of surface roughness lies between 0.1 and 30 μm.
